(19) United States
(12) Patent Application Publication
(10) Pub. No.: US 2013/0322402 A1
(43) Pub. Date: Dec. 5, 2013

(54) METHOD AND APPARATUS FOR PERFORMING CHANNEL CODING CONTROL

(71) Applicant: MEDIATEK INC., Hsin-Chu (TW)

(72) Inventors: Lun-Han Chang, Taoyuan County (TW); Wei-De Wu, Hsinchu City (TW); Wei-Nan Sun, Hsinchu County (TW)

(73) Assignee: MEDIATEK INC., Hsin-Chu (TW)

(21) Appl. No.: 13/798,132

(22) Filed: Mar. 13, 2013

Related U.S. Application Data
(60) Provisional application No. 61/653,606, filed on May 31, 2012.

(51) Int. Cl. H04W 36/20

(52) U.S. Cl. CPC H04W 36/20
USPC 370/331

(57) ABSTRACT

A method and apparatus for performing channel coding control are provided. The method may include: adding CRC bits to information bits, for performing channel encoding corresponding to the electronic device to generate an encoding result; performing data arrangement corresponding to the electronic device on at least one of the encoding result and a derivative thereof to generate a data arrangement result, for use of generating a processing result corresponding to the electronic device; and transmitting the processing result corresponding to the electronic device to UE. More particularly, for a same set of information bits to be transmitted from a plurality of electronic devices including the electronic device to the UE, the encoding result could be different from that in any other electronic device within the electronic devices, and a coding chain represented by the data arrangement result is different from that in any other electronic device within the electronic devices.

### CROSS REFERENCE TO RELATED APPLICATIONS

This application claims the benefit of U.S. Provisional Application No. 61/653,606, which was filed on May 31, 2012, and is included herein by reference.

### BACKGROUND

The present invention relates to channel coding, and more particularly, to a method for performing channel coding control, and to an associated apparatus.

According to the related art, different Node Bs may transmit the same data of the same order to the user equipment (UE) at the same time based upon a conventional soft-handover/handoff (SHO) control scheme. However, some problems may occur. For example, according to the analysis in system level simulation (SLS), in a situation where the mobile devices (e.g. mobile phones) of one third of the users in a cell are operating in the SHO condition, these SHO users, the users whose mobile devices are operating in the SHO condition, may occupy about two thirds of the power consumption of the cell since their locations are around the cell edge. In addition, because of the larger path loss and stronger interference signal from other cells, the Node B of the cell may need to increase the power levels of transmission to maintain the signal quality. Thus, a novel method is required for reducing the power consumption and improving the system capacity.

### SUMMARY

It is therefore an objective of the claimed invention to provide a method for performing channel coding control, and to provide an associated apparatus, in order to solve the above-mentioned problems.

It is another objective of the claimed invention to provide a method for performing channel coding control, and to provide an associated apparatus, in order to enhance the channel coding gain and the diversity, and more particularly, to improve the system capacity with aid of early termination.

According to at least one preferred embodiment, a method for performing channel coding control is provided, where the method is applied to an electronic device. The method comprises: adding Cyclic Redundancy Check (CRC) bits to information bits, for performing channel encoding corresponding to the electronic device to generate an encoding result; performing data arrangement corresponding to the electronic device on at least one of the encoding result and a derivative thereof to generate a data arrangement result, for use of generating a processing result corresponding to the electronic device; and transmitting the processing result corresponding to the electronic device to user equipment (UE). More particularly, for a same set of information bits to be transmitted from a plurality of electronic devices comprising the electronic device to the UE, the encoding result could be different from that in any other electronic device within the plurality of electronic devices, and a coding chain represented by the data arrangement result is different from that in any other electronic device within the plurality of electronic devices. For example, for the same set of information bits, the encoding result is different from that in any other electronic device within the plurality of electronic devices. In another example, for the same set of information bits, the encoding result is the same as that in at least one other electronic device within the plurality of electronic devices.

According to at least one preferred embodiment, an apparatus for performing channel coding control is provided, where the apparatus comprises at least one portion of an electronic device. The apparatus comprises at least one coding control module, and further comprises a transmitter coupled to the processing circuit. For example, at least one portion (e.g. a portion or all) of the at least one coding control module can be implemented with a hardware circuit. The at least one coding control module is arranged to add CRC bits to information bits, for performing channel encoding corresponding to the electronic device to generate an encoding result. In addition, the at least one coding control module is arranged to perform data arrangement corresponding to the electronic device on at least one of the encoding result and a derivative thereof to generate a data arrangement result, for use of generating a processing result corresponding to the electronic device. Additionally, the transmitter is arranged to transmit the processing result corresponding to the electronic device to UE. More particularly, for a same set of information bits to be transmitted from a plurality of electronic devices comprising the electronic device to the UE, the encoding result could be different from that in any other electronic device within the plurality of electronic devices, and a coding chain represented by the data arrangement result is different from that in any other electronic device within the plurality of electronic devices. For example, for the same set of information bits, the encoding result is different from that in any other electronic device within the plurality of electronic devices. In another example, for the same set of information bits, the encoding result is the same as that in at least one other electronic device within the plurality of electronic devices.

According to at least one preferred embodiment, a method for performing channel coding control is provided, where the method is applied to an electronic device. The method comprises: receiving from a plurality of Node Bs a plurality of wireless signals representing a plurality of processing results of the Node Bs, respectively, wherein the processing results of the Node Bs are derivatives of a plurality of data arrangement results of the Node Bs, respectively, and the data arrangement results of the Node Bs are derivatives of a plurality of encoding results of the Node Bs, respectively, the encoding results corresponding to a same set of information bits to be transmitted from the Node Bs to the electronic device, respectively; and reconstructing the processing results of the Node Bs according to the wireless signals received from the Node Bs, respectively, for performing channel decoding according to derivatives of the reconstructed processing results, in order to recover the same set of information bits. More particularly, for the same set of information bits to be transmitted from the plurality of Node Bs to the electronic device, the encoding results could be different from each other, and coding chains respectively represented by the data arrangement results are different from each other. For example, for the same set of information bits, the encoding results are different from each other. In another example, for the same set of information bits, one of the encoding results is the same as at least one other encoding result within the plurality of encoding results.

According to at least one preferred embodiment, an apparatus for performing channel coding control is provided, where the apparatus comprises at least one portion of an electronic device. The apparatus comprises a plurality of receivers, and further comprises at least one coding control module. For example, at least one portion (e.g. a portion or all) of the at least one coding control module can be implemented with a hardware circuit. The receivers are arranged to receive from a plurality of Node Bs a plurality of wireless signals representing a plurality of processing results of the Node Bs, respectively, wherein the processing results of the Node Bs are derivatives of a plurality of data arrangement results of the Node Bs, respectively, and the data arrangement results of the Node Bs are derivatives of a plurality of encoding results of the Node Bs, respectively, the encoding results corresponding to a same set of information bits to be transmitted from the Node Bs to the electronic device, respectively. In addition, the at least one coding control module is arranged to reconstruct the processing results of the Node Bs according to the wireless signals received from the Node Bs, respectively, for performing channel decoding according to derivatives of the reconstructed processing results, in order to recover the same set of information bits. More particularly, for the same set of information bits to be transmitted from the plurality of Node Bs to the electronic device, the encoding results could be different from each other, and coding chains respectively represented by the data arrangement results are different from each other. For example, for the same set of information bits, the encoding results are different from each other. In another example, for the same set of information bits, one of the encoding results is the same as at least one other encoding result within the plurality of encoding results.

It is an advantage of the present invention that the present invention method and apparatus can provide multiple types of new channel coding schemes suitable for downlink (DL) soft-handover/handoff (SHO) scenario to enhance the channel coding gain and the diversity. In addition, in the SHO condition, the enhanced channel coding gain may cause the overall system power consumption to be reduced. Additionally, the present invention method and apparatus can enhance the system capacity with the aid of early termination, and more particularly, can reach an early termination condition faster than as usual.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing channel coding control according to a first embodiment of the present invention, where the apparatus shown in FIG. 1 corresponds to the transmitter side (e.g. a Node B).

FIG. 2 illustrates another apparatus for performing channel coding control according to the embodiment shown in FIG. 1, where the apparatus shown in FIG. 2 corresponds to the receiver side (e.g. the associated User Equipment (UE)).

FIG. 3 is a flowchart of a method for performing channel coding control according to an embodiment of the present invention.

FIG. 4 illustrates some implementation details involved with the method shown in FIG. 3 according to an embodiment of the present invention.

FIG. 5 illustrates an interleaving control scheme involved with the method shown in FIG. 3 according to an embodiment of the present invention.

FIG. 6 illustrates a data arrangement control scheme involved with the method shown in FIG. 3 according to an embodiment of the present invention.

FIG. 7 illustrates a data arrangement control scheme involved with the method shown in FIG. 3 according to another embodiment of the present invention.

FIG. 8 illustrates a data arrangement control scheme involved with the method shown in FIG. 3 according to yet another embodiment of the present invention.

FIG. 9 is a flowchart of a method for performing channel coding control according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

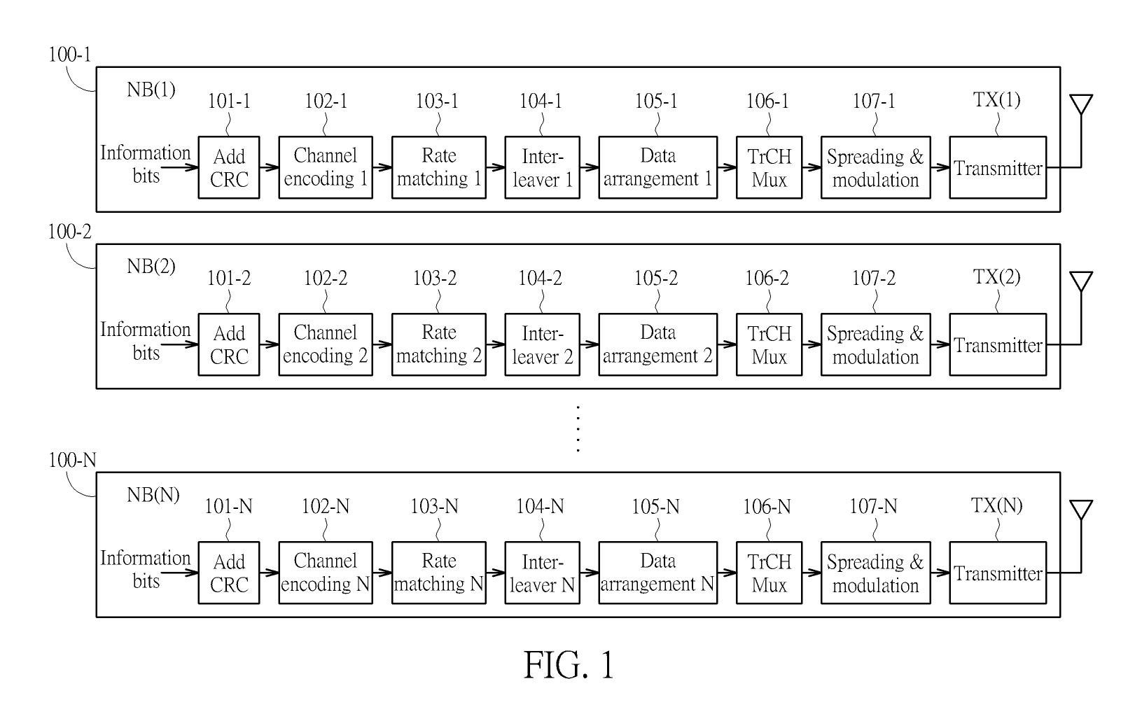

Please refer to FIG. 1, which illustrates a diagram of an apparatus 100-n for performing channel coding control according to a first embodiment of the present invention, where the index n may represent a positive integer falling within the range of the interval [1, N] with N being a positive integer that is greater than one, and the apparatus 100-n shown in FIG. 1 corresponds to the transmitter side (e.g. a Node B). For example, the apparatus 100-n may comprise at least one portion (e.g. a portion or all) of an electronic device, and the electronic device can be the Node B corresponding to the index n. For brevity, the apparatus 100-n shown in FIG. 1 are labeled with the notation NB(n), in which “NB” stands for the Node B under consideration, i.e. the notation NB(n) can be utilized for representing the Node B corresponding to the index n. This is for illustrative purposes only, and is not meant to be a limitation of the present invention. In another example, the apparatus 100 may comprise a system (more particularly, a network control system or a telecommunications control system) comprising the electronic device mentioned above. Examples of the electronic device may include, but not limited to, a computer such as a server or a personal computer, and more particularly, a computer system of the Node B corresponding to the index n.

As shown in FIG. 1, the apparatus 100-n may comprise a transmitter TX(n), and at least one coding control module comprising multiple coding control sub-modules 101-n, 102-n, 103-n, 104-n, 105-n, 106-n, and 107-n respectively labeled “Add CRC”, “Channel encoding” together with the index n, “Rate matching” together with the index n, “Interleaver” together with the index n, “Data arrangement” together with the index n, “TrCH Mux”, and “Spreading & modulation”, which are explained as follows. The coding control sub-module 101-n is arranged to add Cyclic Redundancy Check (CRC) bits to the information bits, the coding control sub-module 102-n is arranged to perform channel encoding corresponding to the index n to generate an encoding result corresponding to the index n, the coding control sub-module 103-n is arranged to perform rate matching corresponding to the index n on the encoding result to generate a rate matching result corresponding to the index n, the coding control sub-module 104-n is an interleaver arranged to perform interleaving corresponding to the index n on the rate matching result to generate an interleaving result corresponding to the index n, the coding control sub-module 105-n is arranged to perform data arrangement corresponding to the index n to generate a data arrangement result corresponding to the index n, the coding control sub-module 106-n is a Transport Channel (TrCH) multiplexer arranged to perform TrCH multiplexing on the data arrangement result to generate a TrCH multiplexing result, and the coding control sub-module 107-n is arranged to perform spreading and modulation on the TrCH multiplexing result to generate a processing result corresponding to the index n, where the transmitters {TX(n)} (i.e. the transmitters TX(1), TX(2), . . . , and TX(N)) shown in FIG. 1 are arranged to transmit the processing results generated by the coding control sub-modules {107-n} (i.e. the coding control sub-modules 107-1, 107-2, . . . , and 107-1), respectively. This is for illustrative purposes only, and is not meant to be a limitation of the present invention.

For example, at least one portion (e.g. a portion or all) of the aforementioned at least one coding control module of the apparatus 100-n can be implemented with a hardware circuit. Please note that the coding control sub-modules {102-n} vary with respect to the index n, the coding control sub-modules {103-n} vary with respect to the index n, the coding control sub-modules {104-n} vary with respect to the index n, and the coding control sub-modules {105-n} vary with respect to the index n. Typically, the coding control sub-modules {101-n} are equivalent to each other, the coding control sub-modules {106-n} are equivalent to each other, and the coding control sub-modules {107-n} are equivalent to each other.

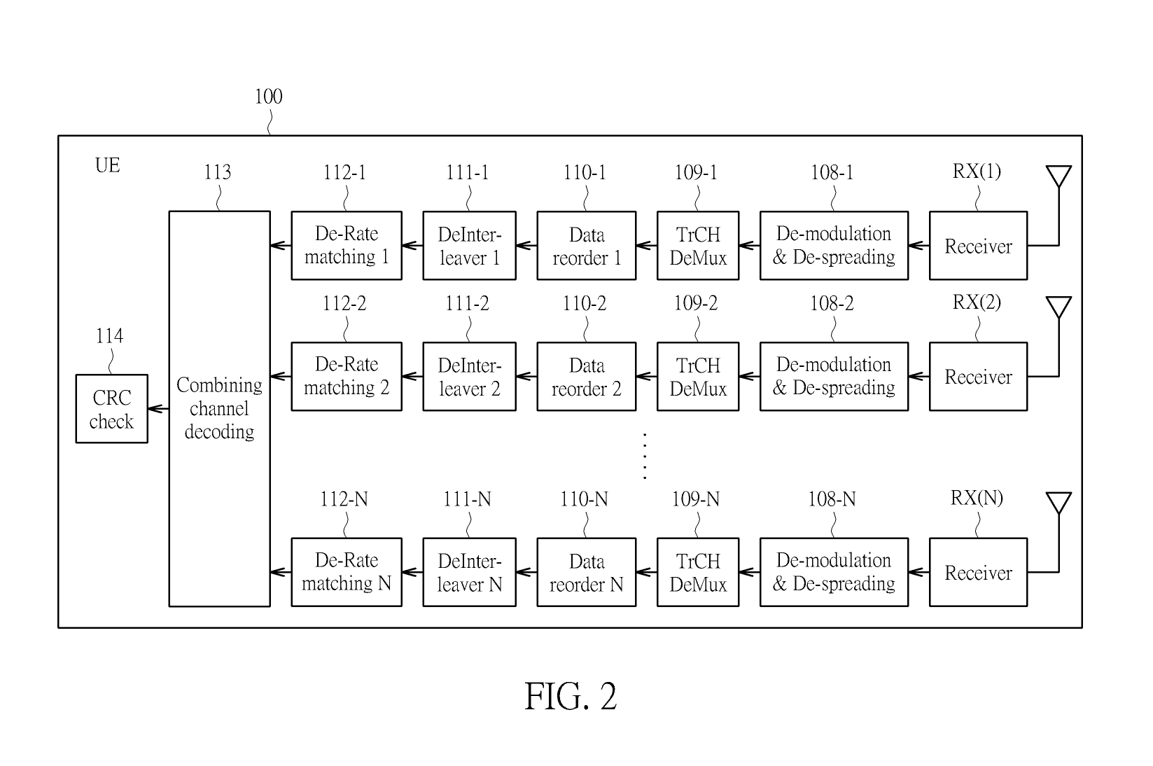

FIG. 2 illustrates another apparatus 100 for performing channel coding control according to the embodiment shown in FIG. 1, where the apparatus 100 shown in FIG. 2 corresponds to the receiver side (e.g. the associated User Equipment (UE)). For example, the apparatus 100 may comprise at least one portion (e.g. a portion or all) of another electronic device, which can be the associated UE corresponding to a plurality of Node Bs such as those represented by the apparatuses 100-1, 100-2, . . . , and 100-N shown in FIG. 1. For brevity, the apparatus 100 shown in FIG. 1 is labeled “UE”. Examples of this electronic device may include, but not limited to, a mobile phone (e.g. a multifunctional mobile phone), a mobile computer (e.g. tablet computer), a personal digital assistant (PDA), and a personal computer such as a laptop computer or desktop computer.

As shown in FIG. 2, the apparatus 100 may comprise a set of receivers {RX(n)}, where the receivers {RX(n)} (i.e. the receivers RX(1), RX(2), . . . , and RX(N)) correspond to the transmitters {TX(n)} (i.e. the transmitters TX(1), TX(2), . . . , and TX(N)) shown in FIG. 1, respectively, and the apparatus 100 may comprise at least one coding control module comprising multiple coding control sub-modules {108-n}, {109-n}, {110-n}, {111-n}, {112-n}, 113, and 114 respectively labeled “De-modulation & De-spreading”, “TrCH DeMux”, “Data reorder” together with the index n, “DeInterleaver” together with the index n, “De-Rate matching” together with the index n, “Combining channel decoding”, and “CRC check”, which are explained as follows. The coding control sub-modules {108-n} are arranged to perform de-modulation and de-spreading, the coding control sub-modules {109-n} are a set of TrCH de-multiplexers arranged to perform TrCH de-multiplexing, the coding control sub-modules {110-n} are arranged to perform data reordering respectively corresponding to (different index values of) the index n, the coding control sub-modules {111-n} are a set of de-interleavers arranged to perform de-interleaving respectively corresponding to (different index values of) the index n, the coding control sub-modules {112-n} are arranged to perform de-rate matching respectively corresponding to (different index values of) the index n, the coding control sub-module 113 is arranged to perform combining channel decoding, and the coding control sub-module 114 is arranged to perform CRC checking, where the coding control sub-modules {108-n} (i.e. the coding control sub-modules 108-1, 108-2, . . . , and 108-1) are arranged to receive and process the output signals of the receivers {RX(n)} (i.e. the receivers RX(1), RX(2), . . . , and RX(N)), respectively. In addition, as the N processing sub-paths respectively form with the coding control sub-modules {108-1, 109-1, 110-1, 111-1, 112-1}, {108-2, 109-2, 110-2, 111-2, 112-2}, . . . , and {108-N, 109-N, 110-N, 111-N, 112-N} are all directed to the coding control sub-module 113, toward the same processing path starting from the coding control sub-module 113, the coding control sub-module 113 may collect those that are output from the coding control sub-modules {112-n} for performing channel decoding. In practice, the coding control sub-modules {108-n}, {109-n}, {110-n}, {111-n}, {112-n}, 113, and 114 perform operations in reverse order with respect to that of the coding control sub-modules {101-n}, {102-n}, {103-n}, {104-n}, {105-n}, {106-n}, and {107-n} shown in FIG. 1, while this embodiment focuses on channel decoding, rather than channel encoding. This is for illustrative purposes only, and is not meant to be a limitation of the present invention.

For example, at least one portion (e.g. a portion or all) of the aforementioned at least one coding control module of the apparatus 100 can be implemented with a hardware circuit. Please note that the coding control sub-modules {110-n} vary with respect to the index n, the coding control sub-modules {111-n} vary with respect to the index n, and the coding control sub-modules {112-n} vary with respect to the index n. Typically, the coding control sub-modules {108-n} are equivalent to each other, and the coding control sub-modules {109-n} are equivalent to each other.

For example, the apparatuses {100-n} may use different coding chains to transmit data. More particularly, the channel coding types, the operations of rate matching, the interleaved patterns, and the operations of data arrangement may vary in the apparatuses 100-1, 100-2, . . . , and 100-N. In addition, the UE may combine the received data (e.g. the data received by the receivers {RX(n)}) to enhance the channel coding gain and to get the diversity gain.

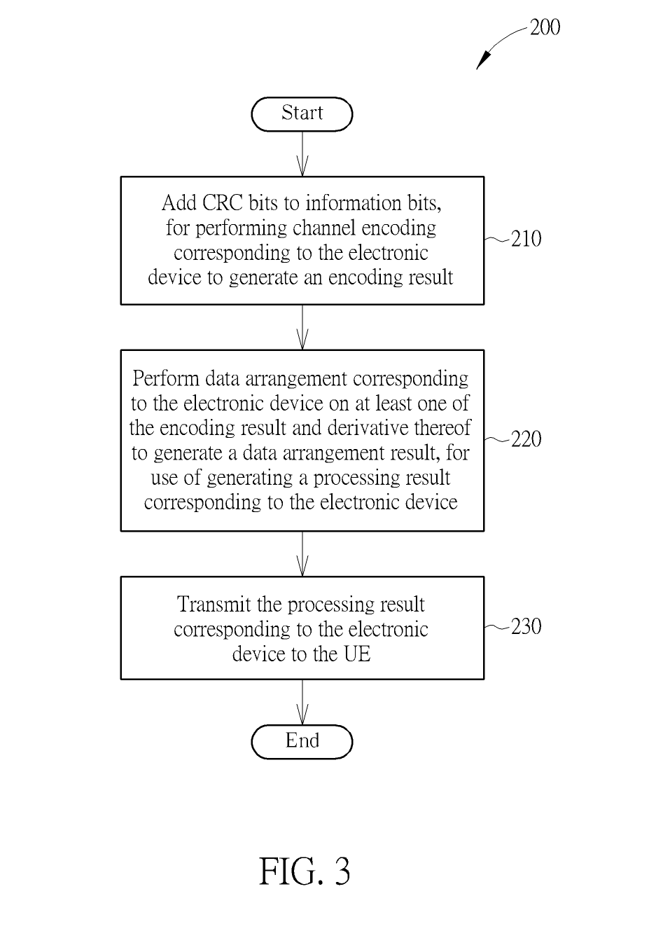

FIG. 3 is a flowchart of a method 200 for performing channel coding control according to an embodiment of the present invention. The method 200 shown in FIG. 3 can be applied to the apparatus 100-n shown in FIG. 1. The method is described as follows.

In Step 210, the aforementioned at least one coding control module of the apparatus 100-n adds the CRC bits to the information bits, for performing channel encoding corresponding to the electronic device (e.g. the Node B corresponding to the index n) to generate an encoding result such as that mentioned above.

In Step 220, the aforementioned at least one coding control module of the apparatus 100-n performs data arrangement corresponding to the electronic device on at least one of the encoding result and a derivative thereof to generate a data arrangement result such as that mentioned above, for use of generating a processing result corresponding to the electronic device (e.g. the Node B corresponding to the index n), such as the aforementioned processing result corresponding to the index n.

In Step 230, the transmitter TX(n) of the apparatus 100-n transmits the processing result corresponding to the electronic device (e.g. the Node B corresponding to the index n) to the UE under consideration, such as that shown in FIG. 2.

According to this embodiment, for the same set of information bits to be transmitted from a plurality of electronic devices (e.g. the Node Bs shown in FIG. 1) comprising this electronic device (e.g. the Node B corresponding to the index n) to the UE, the encoding result mentioned in Step 210 could be different from that in any other electronic device within the plurality of electronic devices, and a coding chain represented by the data arrangement result mentioned in Step 220 is different from that in any other electronic device within the plurality of electronic devices. For example, for the same set of information bits, the encoding result mentioned in Step 210 is different from that in any other electronic device within the plurality of electronic devices. In another example, for the same set of information bits, the encoding result mentioned in Step 210 is the same as that in at least one other electronic device within the plurality of electronic devices. More particularly, for the same set of information bits to be transmitted from the plurality of electronic devices (e.g. the Node Bs shown in FIG. 1) comprising this electronic device (e.g. the Node B corresponding to the index n) to the UE, the processing result in Step 220 corresponding to this electronic device is different from that in any other electronic device within the plurality of electronic devices.

In addition, the aforementioned at least one coding control module of the apparatus 100-n performs rate matching corresponding to this electronic device on the encoding result to generate a rate matching result such as that mentioned above, where for the same set of information bits to be transmitted from the plurality of electronic devices (e.g. the Node Bs shown in FIG. 1) comprising this electronic device (e.g. the Node B corresponding to the index n) to the UE, the rate matching result corresponding to this electronic device could be different from that in any other electronic device within the plurality of electronic devices. For example, for the same set of information bits, the rate matching result corresponding to this electronic device is different from that in any other electronic device within the plurality of electronic devices. In another example, for the same set of information bits, the rate matching result corresponding to this electronic device is the same as that in at least one other electronic device within the plurality of electronic devices. More particularly, the aforementioned at least one coding control module of the apparatus 100-n further performs interleaving corresponding to this electronic device on the rate matching result to generate an interleaving result such as that mentioned above, where for the same set of information bits to be transmitted from the plurality of electronic devices (e.g. the Node Bs shown in FIG. 1) comprising this electronic device (e.g. the Node B corresponding to the index n) to the UE, the interleaving result corresponding to this electronic device could be different from that in any other electronic device within the plurality of electronic devices. For example, for the same set of information bits, the interleaving result corresponding to this electronic device is different from that in any other electronic device within the plurality of electronic devices. In another example, for the same set of information bits, the interleaving result corresponding to this electronic device is the same as that in at least one other electronic device within the plurality of electronic devices.

Additionally, the aforementioned at least one coding control module of the apparatus 100-n performs TrCH multiplexing on the data arrangement result to generate a TrCH multiplexing result such as that mentioned above. More particularly, the aforementioned at least one coding control module of the apparatus 100-n performs spreading and modulation on the TrCH multiplexing result to generate the processing result mentioned in Step 220.

Some implementation details are further described below. According to some embodiments, such as the embodiment shown in FIG. 3 and some variations thereof, the CRC bits (or the CRC tail bits) can be added after the information bits. Regarding channel encoding, the coding control sub-module 102-n can use any channel coding type (e.g. the coding types of the repetition code, the convolutional code, the Turbo code, the low-density parity-check (LDPC) code, the repeat-accumulate (RA) code, the block code, etc.), where the channel encoding functions respectively for the apparatuses {100-n} can be different. For example, the coding control sub-module 102-1 can perform convolutional encoding with polynomial generator No. 1, and the coding control sub-module 102-2 can perform another type of convolutional encoding with polynomial generator No. 2, and so on. In another example, the coding control sub-module 102-1 can perform Turbo encoding with redundant version No. 1, and the coding control sub-module 102-2 can perform another type of Turbo encoding with redundant version No. 2, and so on. In another example, the coding control sub-module 102-1 can perform channel encoding using a repetition code, and the coding control sub-module 102-2 can perform channel encoding using a Turbo code, where the other coding control sub-modules within the coding control sub-modules {102-n} can perform channel encoding using other codes, respectively.

In addition, the coding control sub-module 103-n can puncture or repeat the encoded bits to fill the capacity of a physical channel (PhCH) during one transmission time interval (TTI). Regarding interleaving the transmitted bits, for example, the coding control sub-module 104-n can be implemented with a block interleaver used for a whole encoded code word during one TTI. This is for illustrative purposes only, and is not meant to be a limitation of the present invention. In another example, the coding control sub-module 104-n can be implemented with three block interleavers used individually for the systematic part and two parity parts of the encoded turbo code word during one TTI. In another example, the coding control sub-module 104-n can be implemented with a block interleaver (such as that of the size “R×C”) whose parameters “R” (which stands for the row size) and “C” (which stands for the column size) on the number of cells in the active set (e.g. the number of transmitter in DL SHO) and the number of transmitted data bits per slot, respectively, in order to disturb the encoded code word during one TTI. After interleaving, the systematic or the parity bits are uniformly distributed in each data slot. As a result, the UE can reach an early termination condition faster than as usual.

Additionally, the coding control sub-module 105-n can select the transmitted bit sequence. More particularly, the Node Bs can coordinate their efforts and transmit different data sequences to the UE. For example, if Turbo code is used, the systematic bits can be transmitted first. At the case of short data length, earlier termination can be reached. In another example, each Node B transmits by using a data sequence differing from that of any other Node B within the plurality of Node Bs. As a result, the UE can receive the whole data sequence earlier. In practice, the coding control sub-module 106-n can multiplex the TrCH data onto a physical channel (PhCH), and the coding control sub-module 107-n can spread, scramble, and modulate the transmitted data.

Some or the associated implementation details corresponding to the apparatus 100 are described below, the coding control sub-module 108-n can de-modulate, de-scramble, and de-spread the received data from the Node Bs, and the coding control sub-module 109-n can de-multiplex the PhCH data bits onto each TrCH. In addition, the coding control sub-module 110-n can re-order the received data sequence depending on the associated data arrangement performed in the corresponding Node B, such as the associated data arrangement performed in the coding control sub-module 105-n, and the coding control sub-module 111-n can de-interleave the received data and the coding control sub-module 112-n can de-puncture (e.g. fill zero) or de-repetition (e.g. combine the repetition bits) the data. Additionally, the coding control sub-module 113 takes the overall received bits from the Node Bs into the channel decoder (e.g. a channel decoding unit of the coding control sub-module 113), and the coding control sub-module 114 checks the CRC results.

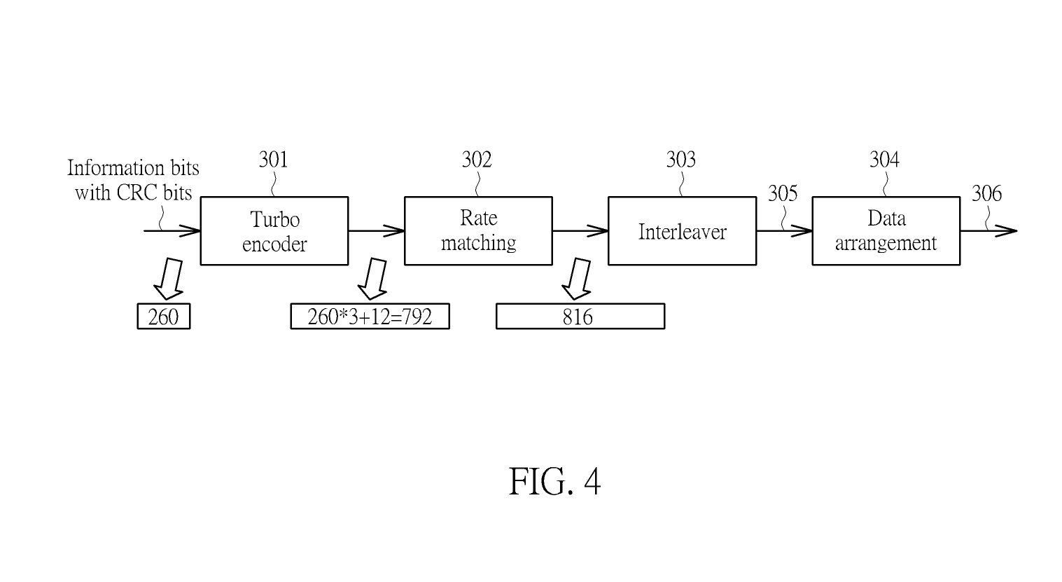

FIG. 4 illustrates some implementation details involved with the method 200 shown in FIG. 3 according to an embodiment of the present invention. The turbo encoder 301 can be taken as an example of the coding control sub-module 102-n, the rate matching sub-module 302 (labeled “Rate matching”, for brevity) can be taken as an example of the coding control sub-module 103-n, the interleaver 303 can be taken as an example of the coding control sub-module 104-n, and the data arrangement sub-module 304 can be taken as an example of the coding control sub-module 105-n.

For example, the information bits may comprise 244 bits and the CRC bits may comprise 16 bits, and therefore the data after adding the CRC bits (i.e. the information bits together with the CRC bits) may comprise 260 bits (labeled “260” in FIG. 4). After the turbo encoder 301 performs turbo encoding, the encoding result generated by the turbo encoder 301 may comprise (260*3+12) bits i.e. 792 bits (labeled “260*3+12=792” in FIG. 4). After the rate matching sub-module 302 performs rate matching, the rate matching result generated by the rate matching sub-module 302 may comprise 816 bits (labeled “816” in FIG. 4). After the interleaver 303 performs interleaving, the interleaving result 305 generated by the interleaver 303 may comprise 816 bits that have been interleaved from the 816 bits of the rate matching result. After the data arrangement sub-module 304 performs data arrangement, the data arrangement result 306 generated by the data arrangement sub-module 304 may comprise a set of data sequences (e.g. a first data sequence, a second data sequence, and a third data sequence, such as the data sequences {S1, S2, S3} transmitted in the order of S1, S2, and S3) corresponding to one TTI, where each data sequence of the set of data sequences may comprise some partial data arranged in some slots of some predefined arrangement order. In practice, the set of data sequences may be arranged to fill the capacity of a PhCh during one TTI. This is for illustrative purposes only, and is not meant to be a limitation of the present invention. Please note that the set of data sequences may correspond to one or more frames (e.g. two frames) complying with some specifications.

Some implementation details regarding the architecture shown in FIG. 4 are further described below. According to some embodiments (e.g. the embodiment shown in FIG. 4 and some variations thereof), the turbo encoder 301 can be a turbo encoder whose code rate is equal to ⅓, where the encoded bits comprise (260*3+12) bits, i.e. 792 bits. In addition, the rate matching sub-module 302 performs rate matching, and more particularly punctures the input bits or performs repetition on the input bits. For example, the number of output bits can be a multiple of the number of Node Bs in the DL SHO condition, such as N, multiplied by the number of transmitted data bits per slot. As a result, the data arrangement design can be simple in units of slot. For the SHO condition of two cells (i.e. N=2), the total rate matching output bits may comprise (M×2×34) bits. In a situation where M=12, the total rate matching output bits may comprise (12×2×34) bits, i.e. 816 bits. In this example, the number of transmitted data bits per slot is equal to 34.

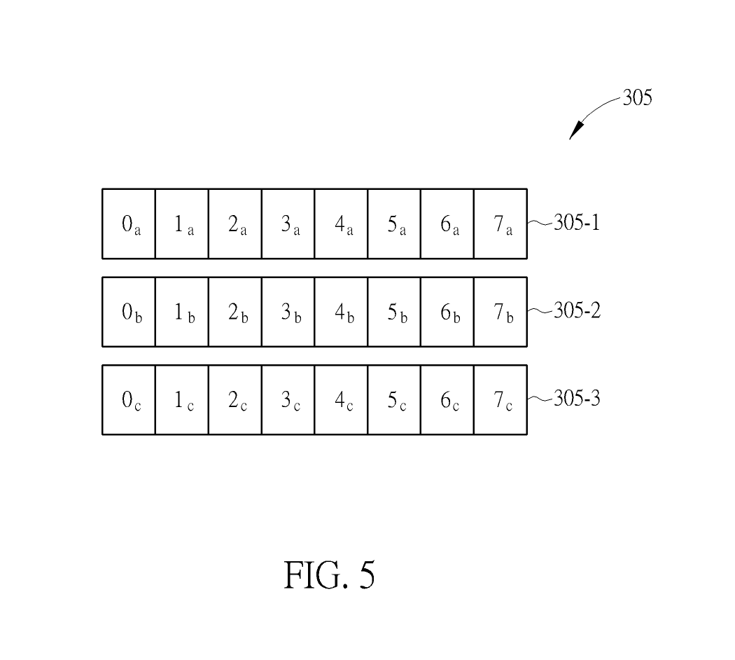

FIG. 5 illustrates an interleaving control scheme involved with the method 200 shown in FIG. 3 according to an embodiment of the present invention. For example, the interleaving result 305 generated by the interleaver 303 can be divided into three parts 305-1, 305-2, and 305-3 shown in FIG. 5, where each part of the three parts 305-1, 305-2, and 305-3 may comprise some partial data corresponding to a plurality of slots, which may comprise eight slots in this embodiment. More particularly, the part 305-1 may comprise partial data {0ₐ, 1ₐ, 2ₐ, 3ₐ, 4ₐ, 5ₐ, 6ₐ, 7ₐ} corresponding to eight slots, the part 305-2 may comprise partial data {0_{b}, 1_{b}, 2_{b}, 3_{b}, 4_{b}, 5_{b}, 6_{b}, 7_{b}} corresponding to eight slots, and the part 305-3 may comprise partial data {0_{c}, 1_{c}, 2_{c}, 3_{c}, 4_{c}, 5_{c}, 6_{c}, 7_{c}} corresponding to eight slots. In practice, each data slot such as any of those within one of the three parts 305-1, 305-2, and 305-3 may comprise 34 bits, which means the bit count of any of the partial data 0ₐ, 1ₐ, 2ₐ, 3ₐ, 4ₐ, 5ₐ, 6ₐ, 7ₐ, 0_{b}, 1_{b}, 2_{b}, 3_{b}, 4_{b}, 5_{b}, 6_{b}, 7_{b}, 0_{c}, 1_{c}, 2_{c}, 3_{c}, 4_{c}, 5_{c}, 6_{c}, or 7, is equivalent to 34. For example, the part 305-1 may represent a systematic part, and the parts 305-2 and 305-3 may represent two parity parts, respectively, where the bits in the part 305-1 are all systematic bits, while the bits in the part 305-2 can be regarded as a parity bit sequence and the bits in the part 305-3 can be regarded as another parity bit sequence. This is for illustrative purposes only, and is not meant to be a limitation of the present invention. According to different variations of this embodiment, after interleaving is performed, the systematic and the parity bits are uniformly distributed in each data slot.

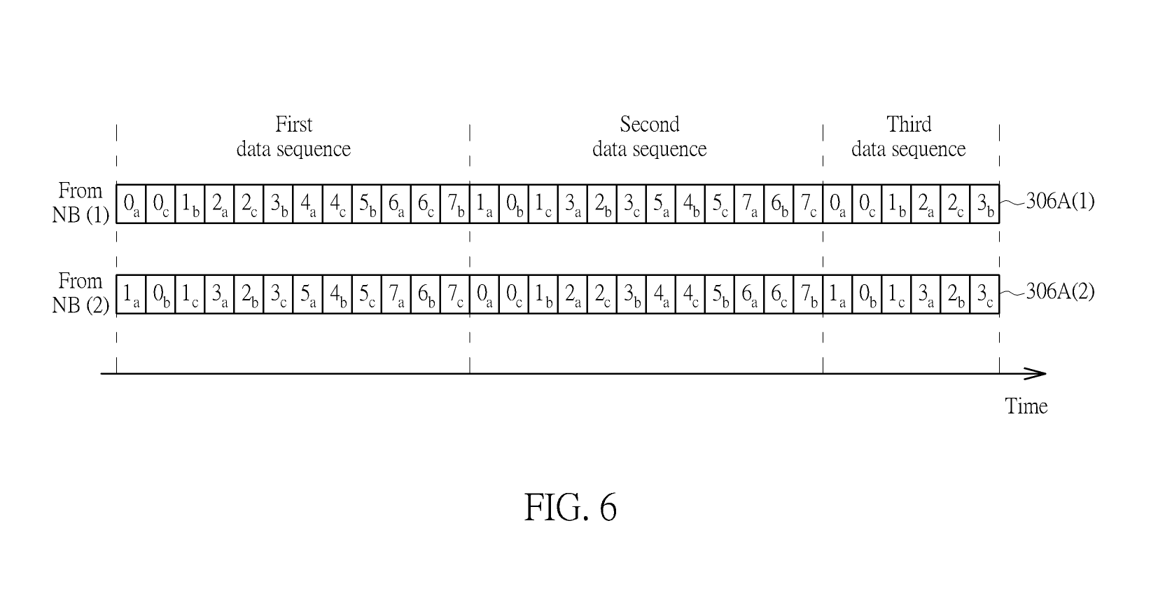

FIG. 6 illustrates a data arrangement control scheme involved with the method 200 shown in FIG. 3 according to an embodiment of the present invention. For example, in a situation where the UE is arranged to operate in the SHO condition and the number of Node Bs supporting the associated SHO control is equal to two (i.e. N=2), the data arrangement result 306A(1) can be taken as an example of the data arrangement result 306 generated by the data arrangement sub-module 304 of the apparatus 100-1, which can be the Node B NB(1) in this embodiment, and the data arrangement result 306A(2) can be taken as an example of the data arrangement result 306 generated by the data arrangement sub-module 304 of the apparatus 100-2, which can be the Node B NB(2) in this embodiment.

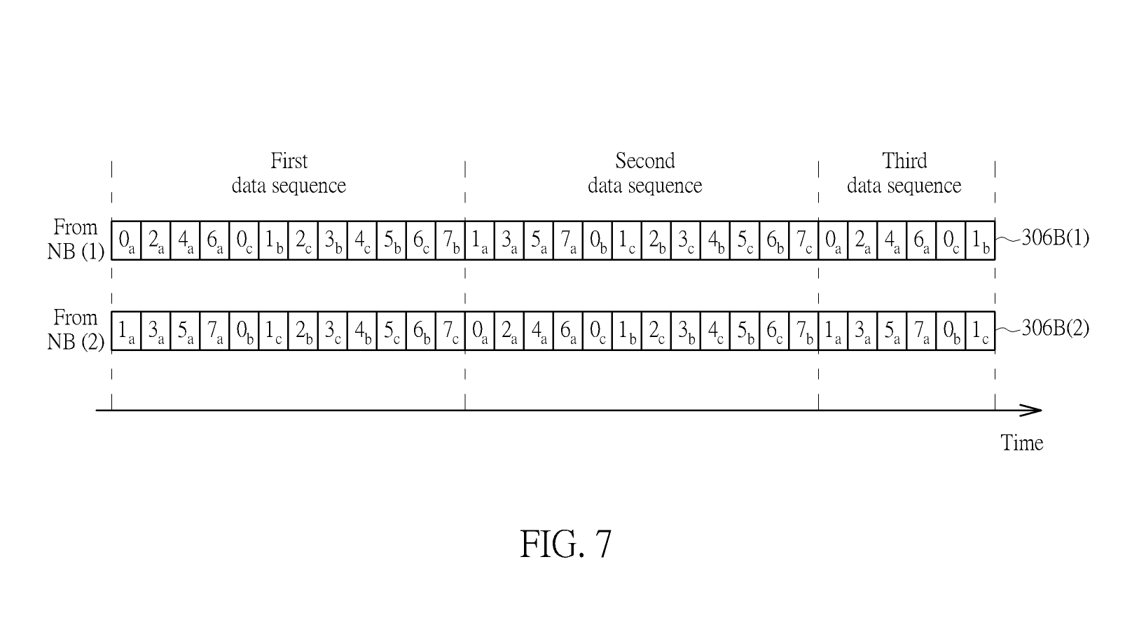

FIG. 7 illustrates a data arrangement control scheme involved with the method 200 shown in FIG. 3 according to another embodiment of the present invention. For example, in a situation where the UE is arranged to operate in the SHO condition and the number of Node Bs supporting the associated SHO control is equal to two (i.e. N=2), the data arrangement result 306B(1) can be taken as an example of the data arrangement result 306 generated by the data arrangement sub-module 304 of the apparatus 100-1, which can be the Node B NB(1) in this embodiment, and the data arrangement result 306B(2) can be taken as an example of the data arrangement result 306 generated by the data arrangement sub-module 304 of the apparatus 100-2, which can be the Node B NB(2) in this embodiment.

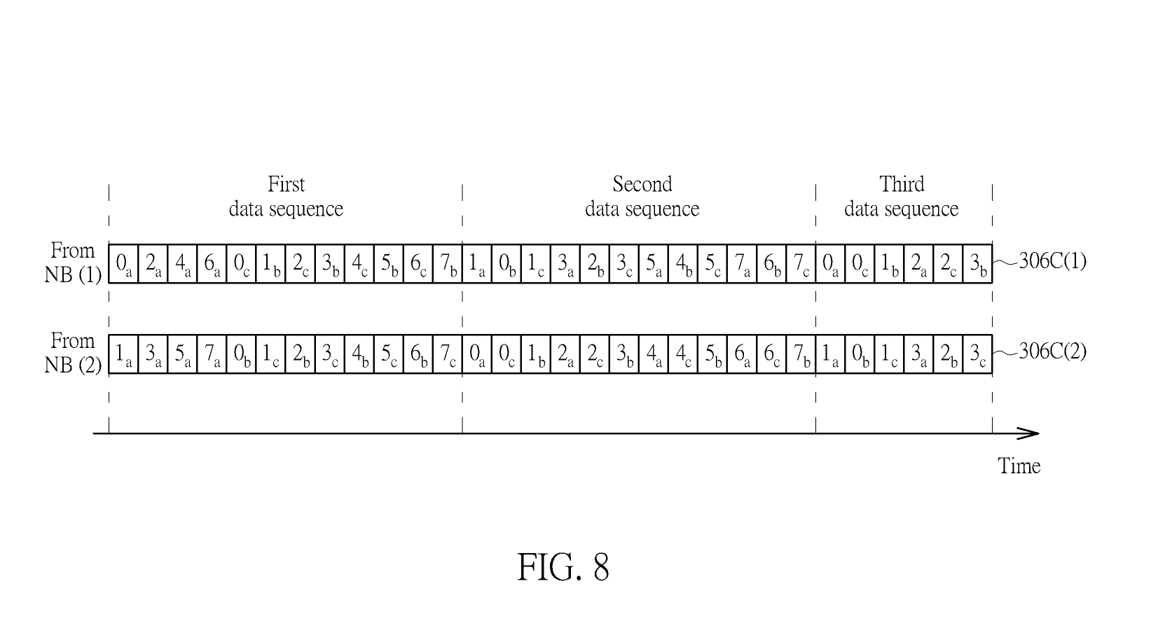

FIG. 8 illustrates a data arrangement control scheme involved with the method 200 shown in FIG. 3 according to yet another embodiment of the present invention. For example, in a situation where the UE is arranged to operate in the SHO condition and the number of Node Bs supporting the associated SHO control is equal to two (i.e. N=2), the data arrangement result 306C(1) can be taken as an example of the data arrangement result 306 generated by the data arrangement sub-module 304 of the apparatus 100-1, which can be the Node B NB(1) in this embodiment, and the data arrangement result 306C(2) can be taken as an example of the data arrangement result 306 generated by the data arrangement sub-module 304 of the apparatus 100-2, which can be the Node B NB(2) in this embodiment.

According to some embodiments (e.g. the embodiment shown in FIG. 4 and some variations thereof), the data arrangement sub-module 304 may vary in different Node Bs within the plurality of Node NBs. As a result, the apparatuses {100-n} may transmit data by different sequences, where there are different data arrangement control schemes to arrange the data slots. In addition, the UE can receive the whole data sequence earlier. For example, in a situation where there are two cells supporting the SHO control, the Node Bs of the two cells can transmit the whole data in twelve slots. If the part 305-1 is a group of systematic bits, the apparatuses {100-n} may transmit the systematic bits in higher priority, and more particularly, may transmit the systematic bits first in any of the data sequences such as those shown in FIG. 7. This is for illustrative purposes only, and is not meant to be a limitation of the present invention. In another example, if the encoded bits are uniformly distributed in each data slot, the apparatuses {100-n} may transmit the data slots alternately, and more particularly, may transmit the systematic and the parity bits alternately in any of the data sequences such as those shown in FIG. 6. In another example, the data arrangement control scheme shown in FIG. 8 can be regarded as a hybrid data arrangement control scheme of the data arrangement control scheme respectively shown in FIG. 6 and FIG. 7

In practice, the same data slot can be transmitted by different Node Bs of the plurality of Node Bs in different data sequences. For example, referring again to FIG. 6, the partial data of the second data sequence in the data arrangement result 306A(1) from NB(1) and the partial data of the second data sequence in the data arrangement result 306A(2) from NB(2) are the same as the partial data of the first data sequence in the data arrangement result 306A(2) from NB(2) and the partial data of the first data sequence in the data arrangement result 306A(1) from NB(1), respectively, and the partial data of the third data sequence in the data arrangement result 306A(1) from NB(1) and the partial data of the third data sequence in the data arrangement result 306A(2) from NB(2) are the same as the partial data of the beginning of the second data sequence in the data arrangement result 306A(2) from NB(2) and the partial data of the beginning of the second data sequence in the data arrangement result 306A(1) from NB(1), respectively. In another example, referring to FIG. 7, the partial data of the second data sequence in the data arrangement result 306B(1) from NB(1) and the partial data of the second data sequence in the data arrangement result 306B(2) from NB(2) are the same as the partial data of the first data sequence in the data arrangement result 306B(2) from NB(2) and the partial data of the first data sequence in the data arrangement result 306B(1) from NB(1), respectively, and the partial data of the third data sequence in the data arrangement result 306B(1) from NB(1) and the partial data of the third data sequence in the data arrangement result 306B(2) from NB(2) are the same as the partial data of the beginning of the second data sequence in the data arrangement result 306B(2) from NB(2) and the partial data of the beginning of the second data sequence in the data arrangement result 306B(1) from NB(1), respectively.

As a result, the UE that is operating in the SHO condition may get some diversity gain, no matter whether which of the Node Bs is the best one in transmitting the aforementioned same set of information bits. In addition, the UE can benefit greatly by (or from) the coding gain and diversity among the Node Bs to reduce the required power in the UE. Additionally, the designed interleaved patterns and any of the data arrangement control schemes can enhance the probability of reaching early termination for the UE that is operating in the SHO condition. Therefore, the average transmitted power in the Node Bs can be reduced. Typically, there are one-third users in the SHO scenario and these users waste two-thirds system power consumption. For example, in the Wideband Code Division Multiple Access (WCDMA) system, the interference mainly originates from the signals for other users. By applying the present invention method and apparatus, the less power consumption for each user may also enhance the system capacity to support more users, since the interference from each of the signals for other users can be reduced.

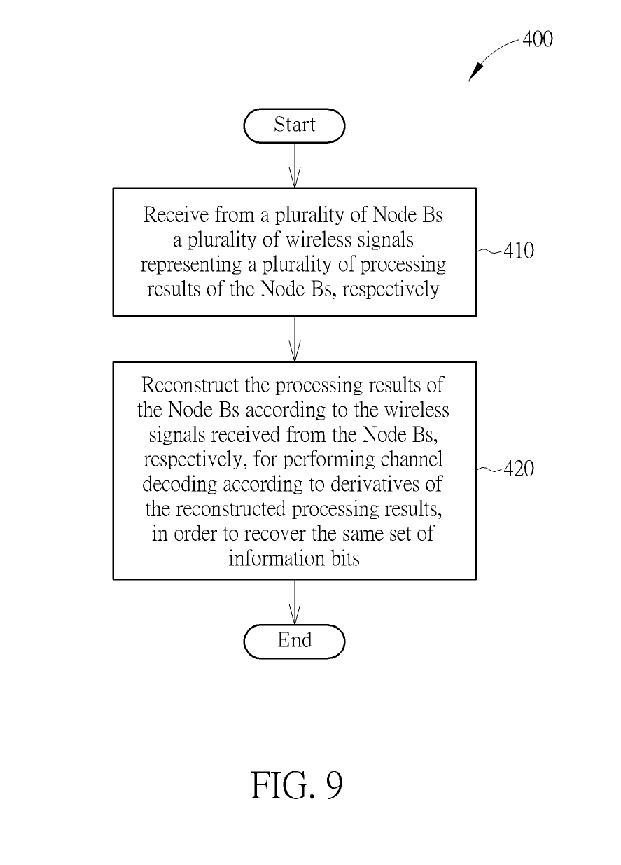

FIG. 9 is a flowchart of a method 400 for performing channel coding control according to another embodiment of the present invention. The method 400 shown in FIG. 9 can be applied to the apparatus 100 shown in FIG. 2. The method is described as follows.

In Step 410, the receivers {RX(n)} receive from a plurality of Node Bs (e.g. the Node Bs of the embodiment shown in FIG. 1) a plurality of wireless signals representing a plurality of processing results of the Node Bs (e.g. the processing results of the embodiment shown in FIG. 1), respectively, where the processing results of the Node Bs are derivatives of a plurality of data arrangement results of the Node Bs (e.g. the data arrangement results of the embodiment shown in FIG. 1), respectively, and the data arrangement results of the Node Bs are derivatives of a plurality of encoding results of the Node Bs (e.g. the encoding results of the embodiment shown in FIG. 1), respectively, the encoding results corresponding to the same set of information bits to be transmitted from the Node Bs to the electronic device of the receiver side (more particularly, the electronic device corresponding to the apparatus 100) such as the UE mentioned in the embodiment shown in FIG. 3, respectively.

In Step 420, the aforementioned at least one coding control module reconstructs (or reproduces) the processing results of the Node Bs according to the wireless signals received from the Node Bs, respectively, for performing channel decoding according to derivatives of the reconstructed processing results, in order to recover the same set of information bits.

According to this embodiment, for the same set of information bits to be transmitted from the plurality of Node Bs to this electronic device (e.g. the UE), the encoding results (e.g. the encoding result mentioned in Step 210) could be different from each other, and coding chains respectively represented by the data arrangement results (e.g. the data arrangement result mentioned in Step 220) are different from each other. For example, for the same set of information bits, the encoding results (e.g. the encoding result mentioned in Step 210) are different from each other. In another example, for the same set of information bits, one of the encoding results (e.g. the encoding result mentioned in Step 210) is the same as at least one other encoding result within the plurality of encoding results. More particularly, for the same set of information bits to be transmitted from the plurality of Node Bs to this electronic device (e.g. the UE), the processing results of the Node Bs (e.g. the processing result mentioned in Step 220) are different from each other.

In addition, the rate matching corresponding to the Node Bs is previously performed on the encoding results of the Node Bs to generate a plurality of rate matching results of the Node Bs (e.g. the rate matching result mentioned in the embodiment shown in FIG. 1), respectively, where for the same set of information bits to be transmitted from the plurality of Node Bs to this electronic device (e.g. the UE), the rate matching results of the Node Bs could be different from each other. For example, for the same set of information bits, the rate matching results of the Node Bs are different from each other. In another example, for the same set of information bits, the rate matching result of one of the Node Bs is the same as that of at least one other Node B within the Node Bs. More particularly, the interleaving corresponding to the Node Bs is previously performed on the rate matching results of the Node Bs to generate a plurality of interleaving results of the Node Bs (e.g. the interleaving result mentioned in the embodiment shown in FIG. 1), respectively, where for the same set of information bits to be transmitted from the plurality of Node Bs to this electronic device (e.g. the UE), the interleaving results of the Node Bs could be different from each other. For example, for the same set of information bits, the interleaving results of the Node Bs are different from each other. In another example, for the same set of information bits, the interleaving result of one of the Node Bs is the same as that of at least one other Node B within the Node Bs.

Additionally, the aforementioned at least one coding control module (more particularly, the coding control sub-modules {108-n}) performs de-modulation and de-spreading on the reconstructed processing results to generate a plurality of de-modulation and de-spreading results, respectively, and the aforementioned at least one coding control module (more particularly, the coding control sub-modules {109-n}) performs TrCH de-multiplexing on the de-modulation and de-spreading results to generate a plurality of de-multiplexing results, respectively. In this embodiment, the aforementioned at least one coding control module (more particularly, the coding control sub-modules {110-n}) performs data reordering, whose operations are reverse operations of data arrangement previously generating the data arrangement results of the Node Bs, on the de-multiplexing results to generate a plurality of data reordering results, respectively. According to this embodiment, the at least one coding control module (more particularly, the coding control sub-modules {111-n}) performs de-interleaving on the data reordering results to generate a plurality of de-interleaving results, respectively, and the at least one coding control module (more particularly, the coding control sub-modules {112-n}) performs de-rate matching on the de-interleaving results to generate a plurality of de-rate matching results, respectively, for performing channel decoding. Please note that the coding control sub-module 113 may collect those that are output from the coding control sub-modules {112-n}, such as the de-rate matching results mentioned above, for performing channel decoding. As a result, the aforementioned at least one coding control module (more particularly, the coding control sub-module 114) performs CRC check to determine whether the same set of information bits is recovered successfully to try reaching an early termination condition of transmitting the same set of information bits, in order to improve the system capacity of the system (e.g. the system comprising the Node Bs) with aid of early termination.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing channel coding control, the method being applied to at least one portion of an electronic device, the method comprising:
adding Cyclic Redundancy Check (CRC) bits to information bits, for performing channel encoding corresponding to the electronic device to generate an encoding result;
performing data arrangement corresponding to the electronic device on at least one of the encoding result and a derivative thereof to generate a data arrangement result, for use of generating a processing result corresponding to the electronic device; and
transmitting the processing result corresponding to the electronic device to user equipment (UE);
wherein for a same set of information bits to be transmitted from a plurality of electronic devices comprising the electronic device to the UE, the encoding result could be different from that in any other electronic device within the plurality of electronic devices, and a coding chain represented by the data arrangement result is different from that in any other electronic device within the plurality of electronic devices.

2. The method of claim 1, wherein for the same set of information bits to be transmitted from the plurality of electronic devices comprising the electronic device to the UE, the processing result corresponding to the electronic device is different from that in any other electronic device within the plurality of electronic devices.

3. The method of claim 1, further comprising:
performing rate matching corresponding to the electronic device on the encoding result to generate a rate matching result.

4. The method of claim 3, wherein for the same set of information bits to be transmitted from the plurality of electronic devices comprising the electronic device to the UE, the rate matching result corresponding to the electronic device could be different from that in any other electronic device within the plurality of electronic devices.

5. The method of claim 3, further comprising:
performing interleaving corresponding to the electronic device on the rate matching result to generate an interleaving result.

6. The method of claim 5, wherein for the same set of information bits to be transmitted from the plurality of electronic devices comprising the electronic device to the UE, the interleaving result corresponding to the electronic device could be different from that in any other electronic device within the plurality of electronic devices.

7. The method of claim 1, further comprising:
performing Transport Channel (TrCH) multiplexing on the data arrangement result to generate a TrCH multiplexing result.

8. The method of claim 7, further comprising:
performing spreading and modulation on the TrCH multiplexing result to generate the processing result.

9. A method for performing channel coding control, the method being applied to at least one portion of an electronic device, the method comprising:
receiving from a plurality of Node Bs a plurality of wireless signals representing a plurality of processing results of the Node Bs, respectively, wherein the processing results of the Node Bs are derivatives of a plurality of data arrangement results of the Node Bs, respectively, and the data arrangement results of the Node Bs are derivatives of a plurality of encoding results of the Node Bs, respectively, the encoding results corresponding to a same set of information bits to be transmitted from the Node Bs to the electronic device, respectively; and
reconstructing the processing results of the Node Bs according to the wireless signals received from the Node Bs, respectively, for performing channel decoding according to derivatives of the reconstructed processing results, in order to recover the same set of information bits;
wherein for the same set of information bits to be transmitted from the plurality of Node Bs to the electronic device, the encoding results could be different from each other, and coding chains respectively represented by the data arrangement results are different from each other.

10. The method of claim 9, wherein for the same set of information bits to be transmitted from the plurality of Node Bs to the electronic device, the processing results of the Node Bs are different from each other.

11. The method of claim 9, wherein rate matching corresponding to the Node Bs is previously performed on the encoding results of the Node Bs to generate a plurality of rate matching results of the Node Bs, respectively; and for the same set of information bits to be transmitted from the plurality of Node Bs to the electronic device, the rate matching results of the Node Bs could be different from each other.

12. The method of claim 11, wherein interleaving corresponding to the Node Bs is previously performed on the rate matching results of the Node Bs to generate a plurality of interleaving results of the Node Bs, respectively; and for the same set of information bits to be transmitted from the plurality of Node Bs to the electronic device, the interleaving results of the Node Bs could be different from each other.

13. The method of claim 9, further comprising:
performing de-modulation and de-spreading on the reconstructed processing results to generate a plurality of de-modulation and de-spreading results, respectively;
performing Transport Channel (TrCH) de-multiplexing on the de-modulation and de-spreading results to generate a plurality of de-multiplexing results, respectively;
performing data reordering, whose operations are reverse operations of data arrangement previously generating the data arrangement results of the Node Bs, on the de-multiplexing results to generate a plurality of data reordering results, respectively;
performing de-interleaving on the data reordering results to generate a plurality of de-interleaving results, respectively; and
performing de-rate matching on the de-interleaving results to generate a plurality of de-rate matching results, respectively, for performing channel decoding.

14. The method of claim 9, further comprising:
performing Cyclic Redundancy Check (CRC) check to determine whether the same set of information bits is recovered successfully to try reaching an early termination condition of transmitting the same set of information bits, in order to improve system capacity of a system, the system comprising the Node Bs, with aid of early termination.

15. An apparatus for performing channel coding control, the apparatus comprising at least one portion of an electronic device, the apparatus comprising:
a plurality of receivers arranged to receive from a plurality of Node Bs a plurality of wireless signals representing a plurality of processing results of the Node Bs, respectively, wherein the processing results of the Node Bs are derivatives of a plurality of data arrangement results of the Node Bs, respectively, and the data arrangement results of the Node Bs are derivatives of a plurality of encoding results of the Node Bs, respectively, the encoding results corresponding to a same set of information bits to be transmitted from the Node Bs to the electronic device, respectively; and
at least one coding control module arranged to reconstruct the processing results of the Node Bs according to the wireless signals received from the Node Bs, respectively, for performing channel decoding according to derivatives of the reconstructed processing results, in order to recover the same set of information bits;
wherein for the same set of information bits to be transmitted from the plurality of Node Bs to the electronic device, the encoding results could be different from each other, and coding chains respectively represented by the data arrangement results are different from each other.

16. The apparatus of claim 15, wherein for the same set of information bits to be transmitted from the plurality of Node Bs to the electronic device, the processing results of the Node Bs are different from each other.

17. The apparatus of claim 15, wherein rate matching corresponding to the Node Bs is previously performed on the encoding results of the Node Bs to generate a plurality of rate matching results of the Node Bs, respectively; and for the same set of information bits to be transmitted from the plurality of Node Bs to the electronic device, the rate matching results of the Node Bs could be different from each other.

18. The apparatus of claim 17, wherein interleaving corresponding to the Node Bs is previously performed on the rate matching results of the Node Bs to generate a plurality of interleaving results of the Node Bs, respectively; and for the same set of information bits to be transmitted from the plurality of Node Bs to the electronic device, the interleaving results of the Node Bs could be different from each other.

19. The apparatus of claim 15, wherein the at least one coding control module performs de-modulation and de-spreading on the reconstructed processing results to generate a plurality of de-modulation and de-spreading results, respectively, performs Transport Channel (TrCH) de-multiplexing on the de-modulation and de-spreading results to generate a plurality of de-multiplexing results, respectively, and performs data reordering, whose operations are reverse operations of data arrangement previously generating the data arrangement results of the Node Bs, on the de-multiplexing results to generate a plurality of data reordering results, respectively; and the at least one coding control module performs de-interleaving on the data reordering results to generate a plurality of de-interleaving results, respectively, and performs de-rate matching on the de-interleaving results to generate a plurality of de-rate matching results, respectively, for performing channel decoding.

20. The apparatus of claim 15, wherein the at least one coding control module performs Cyclic Redundancy Check (CRC) check to determine whether the same set of information bits is recovered successfully to try reaching an early termination condition of transmitting the same set of information bits, in order to improve system capacity of a system, the system comprising the Node Bs, with aid of early termination.
